(19) United States
(12) Patent Application Publication
(10) Pub. No.: US 2015/0175006 A1
(43) Pub. Date: Jun. 25, 2015

(54) Modular Electric Power Supply Adapter Device for Electric Golf Cars and Electric Utility Vehicles

(71) Applicants: Trevor Jason Back, Indianapolis, IN (US); Tyler Jon Back, San Francisco, CA (US)

(72) Inventors: Trevor Jason Back, Indianapolis, IN (US); Tyler Jon Back, San Francisco, CA (US)

(21) Appl. No.: 14/138,079

(22) Filed: Dec. 22, 2013

(51) Int. Cl. B60L 1/00

(52) U.S. Cl. CPC B60L 1/006

(57) ABSTRACT

A modular electric power supply adapter device for electric golf cars and electric utility vehicles is advantageous to the existing power supply adapter device for electric golf cars and electric utility vehicles because it is more convenient and more affordable.

The problem that exists is that each brand of electric golf car or electric utility vehicle has its own uniquely shaped port. Prior to the present invention, the user needed multiple independent devices. The present invention benefits the user because one modular DC converter assembly now can be detachably coupled to a variety of modular base housing assemblies. The modular base housing assemblies have a variety of shapes to fit the uniquely shaped ports in each brand of electric golf car or electric utility vehicle.

A modular electric power supply adapter device plugs into a charging receptacle or IQ port of an electric golf car or electric utility vehicle, and is used to power an electronic apparatus. The main components consist of input electric connectors positioned in a modular base housing assembly adapted to fit a charging receptacle or IQ port of an electric golf car or electric utility vehicle, output and input transfer electric connectors, a DC converter module, and an electrical output fitting adapted to receive an electrical connection such as, but not limited to, a USB, to transmit the DC output power from the DC converter module to the electronic apparatus. The modular DC converter assembly detachably couples to a modular base housing assembly.

### CROSS-REFERENCE TO RELATED APPLICATIONS

This application claims priority to U.S. Provisional Patent Application 61/745,598, filed Dec. 22, 2012 which is incorporated by reference herein.

### REFERENCES CITED

Jun. 7, 2012, Holland, US 2012/0139335

### BACKGROUND OF THE INVENTION

### Field of the Invention

The present invention is in the technical field of power supplies. More particularly, the present invention is in the technical field of adapting electric power from a power source that has relatively high voltage for use in charging an electronic apparatus that cannot use such voltage directly, but requires lower voltage and a specific current. More particularly, the present invention is in the technical field of electric golf cars and electric utility vehicles.

With the rising number of electronic apparatuses being used daily and their increased capabilities and therefore increased power demands, there are several adapters available for sourcing power to charge the batteries within an electronic apparatus over the course of a day. Unfortunately, for people in electric golf cars and electric utility vehicles, there is not yet such a single adapter for tapping into the power supply of different electric golf cars or electric utility vehicles through the vehicles' conveniently located electrical ports of unique shapes and sizes. A modular electric power supply adapter device for electric golf cars and electric utility vehicles is advantageous to the existing power supply adapter device for electric golf cars and electric utility vehicles because it is more convenient and more affordable. The problem that exists is that each brand of electric golf car or electric utility vehicle has its own uniquely shaped electrical port. Prior to the present invention, the user needed multiple independent devices. The present invention benefits the user because one modular DC converter assembly now can be detachably coupled to a plurality of adapter modules. The adapter modules have a variety of shapes to fit the uniquely shaped electrical ports in each brand of electric golf car or electric utility vehicle.

There is a growing number of golf applications for smart phones. For example, GPS (global positioning system) applications are available to help players navigate golf courses. Although the applications are very popular, many golfers are disappointed that their smart phones run out of power before they come to the end of their game at the golf course. There are also several other electronic apparatuses where power is desired while using an electric golf car or electric utility vehicle, such as, but not limited to tablets, GPS devices, watches, and speakers.

What is needed is a simple modular adapter to source the power found at the electrical ports of electric golf cars and electric utility vehicles for use in charging electronic apparatuses.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a top view of an electric power supply adapter device of the present invention;

FIG. 2 is a connection diagram of an electric power supply adapter device of the present invention; and

FIG. 3 is a circuit block diagram of an electric power supply adapter device of the present invention.

### SUMMARY

The above and other objects, which will be apparent to those skilled in the art, are achieved in the present invention which is directed to a modular system for sourcing electrical power from an electrical port of an electric utility vehicle for use by an electronic apparatus, comprising an adapter module configured to make electrical connection with an electrical port of a particular electric utility vehicle that detachably connects to a DC converter module, thereby supplying a first DC input voltage and current from the particular electric utility vehicle to the DC converter module.

The device also includes a DC converter module configured to make electrical connection to both the adapter module and an electrical output fitting, the DC converter module configured to convert the first DC input voltage and current from the adapter module to a second DC output voltage and current for an electrical output fitting.

The device further includes an electrical output fitting in electrical communication with the DC converter module, wherein the second DC output voltage and current is suitable for use by an electronic apparatus.

### DETAILED DESCRIPTION

Embodiments of the current invention include a modular electric power supply adapter device that plugs into accessible electrical ports such as a charging receptacle or a Club Car (trademark) IQ port of an electric golf car or electric utility vehicle [e.g. E-Z-GO (trademark), Club Car (trademark), Yamaha (trademark)]. The charging receptacle is typically used as a method to charge the electric golf car or utility vehicle. The IQ port is typically used to communicate with the Club Car IQ system or IQ Plus system. A device, called the IQDM (IQ Display Module), may be plugged into the IQ port to monitor the Club Car electric golf car or electric utility vehicle. The IQ port may be replaced with IQ DM port, DM port, or data port in various models of Club Car electric golf cars or electric utility vehicles.

According to one aspect of the present invention, the modular DC converter assembly detachably connects to a plurality of uniquely shaped adapter modules. The modular electric power supply adapter device includes input electric connectors contained in an adapter module that is adapted to fit a charging receptacle or IQ port of an electric golf car or electric utility vehicle, which are operationally coupled to output transfer electric connectors to transfer the power to the modular direct current (DC) converter assembly. The modular DC converter assembly includes input transfer electric connectors to transfer the power from an adapter module, a DC converter module to convert input power into the required DC output power, and an electrical output fitting adapted to receive an electrical connection such as, but not limited to, a USB connector, and to transmit the DC output power from the DC converter module to the electronic apparatus, such as but not limited to a mobile phone, smart phone, iPhone (trademark), iPad (trademark), Blackberry (trademark), SkyCaddie (trademark), Garmin (trademark), IZZO GPS (trademark), speakers, watch, and GPS unit. One skilled in the art would understand that there are many methods to convert the incoming DC voltage and current to the desired output DC voltage and current.

Although many of the figures are shown with specific details, it should not be construed that such details are limits to the embodiments of the invention. Many variations in shapes, dimensions, materials of construction, and arrangements of the parts are possible within the embodiments of the invention.

### DEFINITIONS

The term, “electric utility vehicle,” is used to mean electric vehicles generally intended for off road use that have a top speed of less than about 40 mph. Examples include, but are not limited to electric golf cars, electric general utility vehicles such as used by ground services and maintenance departments, electric power mowers, electric lawn care equipment, and small electric tractors. The term, “electric golf car”, sometimes called, “electric golf carts,” is used to mean electric vehicles generally intended to have a top speed of less than 25 mph and carry golfers and their golf clubs. Specific examples of golf cars include, but are not limited to E-Z-GO™, Club Car™, and Yamaha™.

The term “electrical port” may include, but are not limited to, charging receptacles of electric golf cars or electric utility vehicles or IQ ports of Club Car electric golf cars or electric utility vehicles.

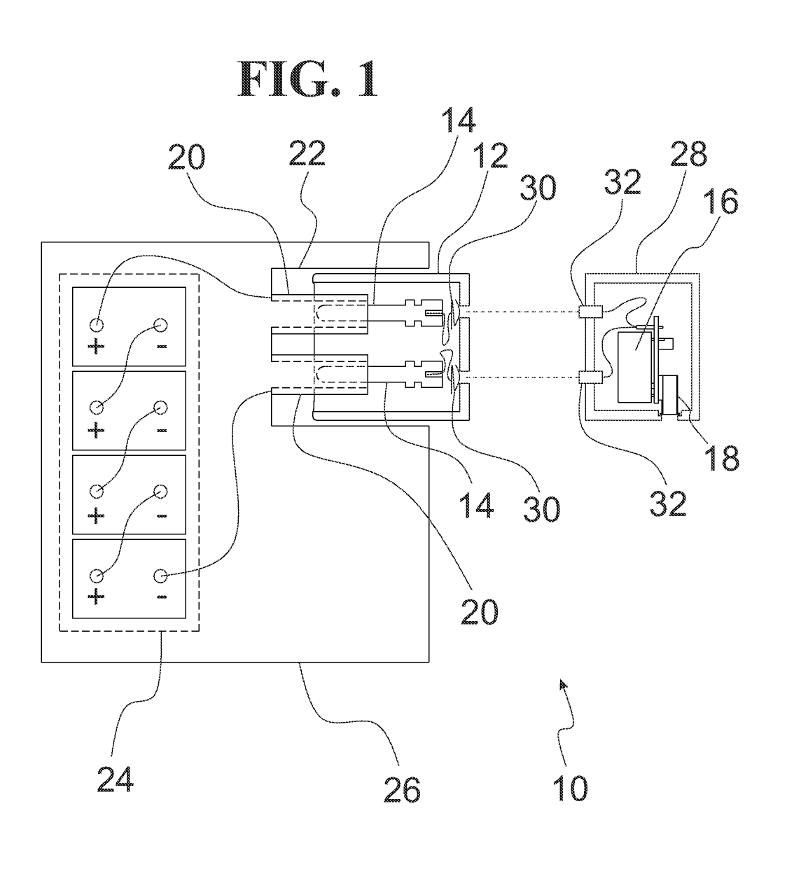

In an exemplary embodiment, as shown in, in FIG. 1 there is a modular electric power supply adapter device 10 having an adapter module 12 containing multiple input electric connectors 14, output transfer electric connectors 30, input transfer electric connectors 32, the DC converter module 16, and an electrical output fitting 18. Each of the input electric connectors 14 is operationally coupled to the output transfer electric connectors 30. Each of the input transfer electric connectors 32 are operationally coupled to the DC converter module 16 which is operationally coupled to the electrical output fitting 18.

In another aspect of the invention, still referring to the schematic drawing of FIG. 1 there is shown the inner cavity of an adapter module 12 and modular DC converter assembly 28. The modular DC converter assembly 28 detachably connects to an adapter module 12. Together, the modular DC converter assembly 28 and an adapter module 12 contain the circuitry for obtaining power from the power source 24 found in an electric golf car or electric utility vehicle 26, converting the power to the required voltage, and transmitting the power to the electronic apparatus.

In yet another aspect of the invention, still referring to the schematic drawing of FIG. 1, an adapter module 12 is designed to align the input electric connectors 14 of the modular electric power supply adapter device 10 with the electric connectors 20 of the electric golf car or electric utility vehicle charging receptacle or IQ port 22. The input electric connectors 14 of the adapter modules 12 have a shape, size, length, and distance between them which allow them to plug into the electric connectors 20 in an electric golf car or electric utility vehicle charging receptacle or IQ port 22.

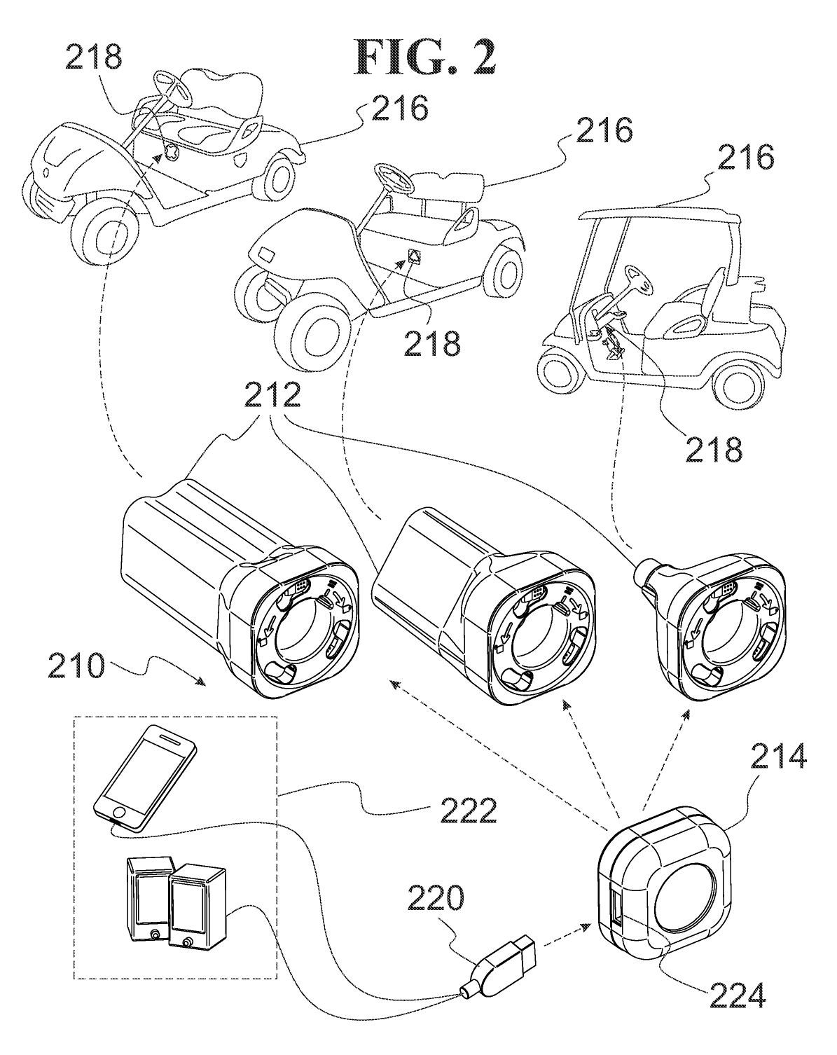

In another exemplary embodiment, as shown in FIG. 2 there is a connection diagram 210 having a plurality of uniquely shaped adapter modules 212, a modular DC converter assembly 214, an electric golf car or electric utility vehicle 216 [such as but not limited to E-Z-GO (trademark), Club Car (trademark), Yamaha (trademark)], a charging receptacle or IQ port 218, a connector cable 220, and an electronic apparatus 222.

In another aspect of the invention, still referring to the schematic drawing of FIG. 2 an adapter module 212 is plugged into a charging receptacle or IQ port 218 of an electric golf car or electric utility vehicle 216. The modular DC converter assembly 214 detachably connects to an adapter module 212. The electronic apparatus 222 is connected to the modular DC converter assembly 214 electrical output fitting 224 through means of a connector cable 220. Thus, the charging receptacle or IQ port 218 of an electric golf car or electric utility vehicle 216 provides power to the electronic apparatus 222.

In another aspect of the invention, still referring to the schematic drawing of FIG. 2 an adapter module 212 is positionable in the charging receptacle or IQ port 218 of an electric golf car or electric utility vehicle 216 such that an adapter module 212 operationally engages the electric connectors within the charging receptacle or IQ port 218. The output transfer electric connectors in an adapter module 212 are able to detachably connect with the input transfer electric connectors in the modular DC converter assembly 214. The connector cable 220 has one end connected to the electrical output fitting 224 of the modular DC converter assembly 214, and the other end terminating in an electric connector connectable to a power port of an electronic apparatus 222.

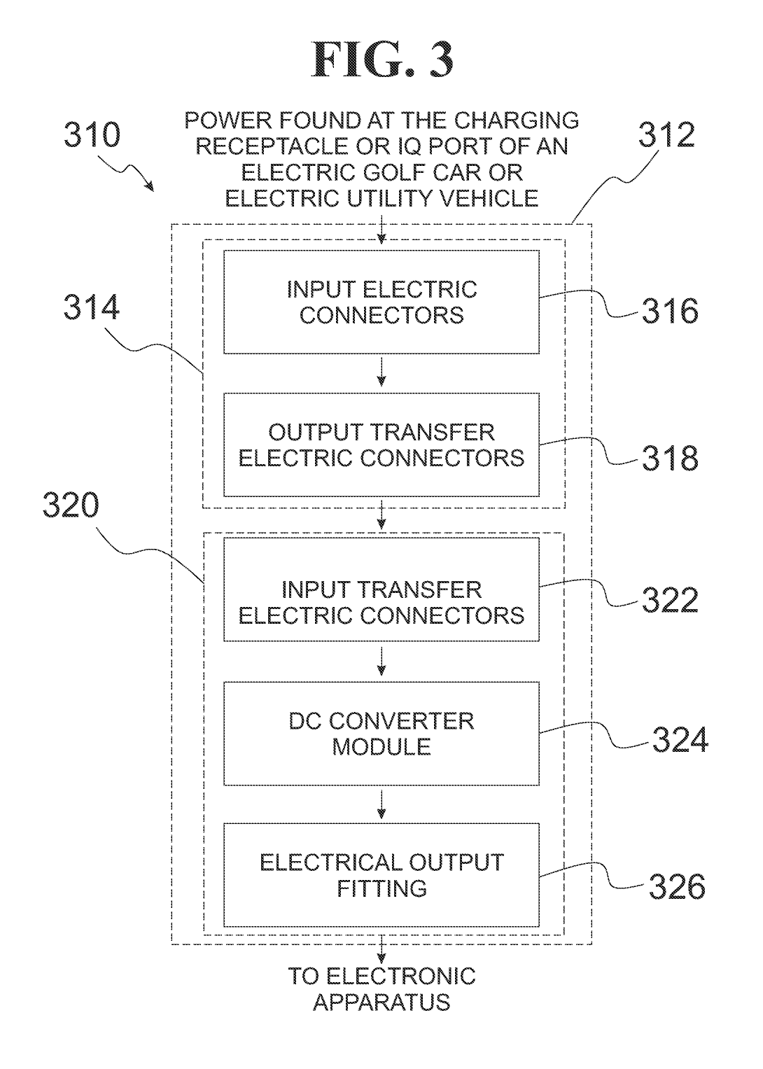

Referring now to the schematic drawing in more detail, in FIG. 3 there is shown a circuit block diagram 310 for showing a modular electric power supply adapter device 312, according to the present embodiment. The modular electric power supply adapter device 312 consists of an adapter module 314 and a modular DC converter assembly 320. An adapter module 314 contains within the housing multiple input electric connectors 316 and output transfer electric connectors 318. The modular DC converter assembly 320 contains within the housing input transfer electric connectors 322, a DC converter module 324, and an electrical output fitting 326.

The advantages of the present embodiment of the invention include, without limitation, the ability to allow an electronic apparatus to be powered conveniently from a charging receptacle or IQ port of an electric golf car or electric utility vehicle. Golf cars and utility vehicles have a charging receptacle or an IQ port that have a shape, electrical connector position, and DC voltage unlike any other type of charging receptacle or IQ port. The embodiment of the current invention allows the modular electric power supply adapter device to conveniently fit into a charging receptacle or IQ port of any electric golf car or electric utility vehicle, convert the input voltage to the required output voltage, and outputs the needed power to an electronic apparatus.

In broad embodiment, power from the electric golf car or electric utility vehicle charging receptacle or IQ port flows through the modular electric power supply adapter device and to an electronic apparatus.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A modular system for sourcing electrical power from an electrical port of an electric utility vehicle for use by an electronic apparatus, comprising:
An adapter module configured to make electrical connection with an electrical port of a particular electric utility vehicle that detachably connects to a DC converter module, thereby supplying a first DC input voltage and current from the particular electric utility vehicle to the DC converter module;
a DC converter module configured to make electrical connection to both the adapter module and an electrical output fitting, the DC converter module configured to convert the first DC input voltage and current from the adapter module to a second DC output voltage and current for an electrical output fitting;
an electrical output fitting in electrical communication with the DC converter module, wherein the second DC output voltage and current is suitable for use by an electronic apparatus.

2. The system of claim 1 wherein the electrical port can be a charging receptacle or an IQ port.

3. The system of claim 1 wherein the electric utility vehicle comprises an electric golf car.

4. The system of claim 3 wherein the golf car is selected from the group consisting of E-Z-GO™, Yamaha™, and Club Car™.

5. The system of claim 1 wherein the input voltage is between about 8 and 100 volts.

6. The system of claim 1 wherein the input voltage is between about 10 and 50 volts.

7. The system of claim 1 wherein the input current is between about 5 and 2000 milliamps.

8. The system of claim 1 wherein the input current is between about 10 and 830 milliamps.

9. The system of claim 1 wherein the output voltage is between about 2 and 10 volts DC.

10. The system of claim 1 wherein the output voltage is between about 4.5 and 5.5 volts DC.

11. The system of claim 1 wherein the output current is between about 0.05 and 10 amps.

12. The system of claim 1 wherein the output current is between about 0.1 and 2.0 amps.

13. The system of claim 1 wherein the electrical output fitting comprises a standard USB port.

14. The system of claim 1 wherein the electrical output fitting comprises two standard USB ports.

15. The system of claim 1 wherein the electrical output fitting comprises an integrated cable adapted to interface with an electronic apparatus.

16. The system in claim 1 wherein the adapter module comprises a plurality of unique adapter modules.
